(19) United States
(12) Patent Application Publication
(10) Pub. No.: US 2015/0158208 A1
(43) Pub. Date: Jun. 11, 2015

(54) COMPOSITE ARTICLES

(71) Applicant: The University of Bristol, Bristol (GB)

(72) Inventors: David WILLIAMS, Bath (GB); Renato RICCI, Bristol (GB); Alex STONEMAN, Bristol (GB); David GROVES, Portishead (GB); Andrew DRANE, Bristol (GB)

(21) Appl. No.: 14/626,027

(22) Filed: Feb. 19, 2015

Related U.S. Application Data
(63) Continuation of application No. PCT/GB2013/052126, filed on Aug. 8, 2013.

(30) Foreign Application Priority Data
Aug. 22, 2012 (GB) 1214917.5

(51) Int. Cl. B29C 35/08; B29C 70/54

(52) U.S. Cl. CPC B29C 35/0805; B29C 70/54; B29C 2035/0827; B29C 2035/0822; B29K 2105/0872

(57) ABSTRACT

Apparatus and methods are disclosed for manufacturing a composite article from a composite material. An exemplary method comprises exposing a contact surface, which comes into contact with another surface during said manufacture, to radiation pulses emitted by a pulsed radiation source.

### CROSS-REFERENCE TO RELATED APPLICATIONS

This application is a continuation under 35 U.S.C. §120 of International Application No. PCT/GB2013/052126, filed Aug. 8, 2013 (published by the International Bureau as International Publication No. WO/2014/029969 on Feb. 27, 2014), which claims priority to United Kingdom Patent Application No. GB1214917.5, filed Aug. 22, 2012. The entire contents of each of the above-referenced applications are hereby incorporated by reference.

### BACKGROUND OF THE INVENTION

1. Field of the Invention

The present invention relates generally to the manufacture of composite articles from layers of composite material and, in particular, although not exclusively, to the heating of composite materials during the manufacture of composite articles.

2. Description of the Related Technology

Composite materials for use in the manufacture of composite articles typically consist of reinforcement fibers, such as carbon fibers or glass fibers, held together by a ‘matrix’ material such as epoxy resin. Such composite materials are typically initially formed as relatively thin, flexible and moldable layers. Before the matrix resin in the layers has been cured (hardened) to produce final articles the layers are often referred to as “prepreg”. Composite articles, formed from layers (or plies) of prepreg, typically require a heat source during manufacture, to increase the tack (stickiness) of the layers as they are brought together. The heat source typically needs to apply energy quickly, consistently and controllably, in order to facilitate efficient manufacture. When the layers of prepreg have been brought together in the form of an article, they are typically subjected to high temperatures and pressures in order to ‘cure’ the composite material—that is, to form the chemical bonds that make the final article characteristically strong and stiff.

It is known that composite articles can be manufactured by a manual process of laying down layers of prepreg and by Automated Fiber Placement (AFP) processes, for example, where robotic arms are controlled to build up layers by applying ribbons of composite material, known as tows, either initially onto a mold (or ‘tool’) or to layers of prepreg that have previously been laid onto a mold. In a typical AFP process, the tows are laid down and then compressed onto the previous layer(s) by using a roller, which is carried by a head at the end of the robotic arm. Embodiments of the present invention are applicable to both manual and AFP processes of all kinds.

From U.S. Pat. No. 7,731,816, for example, it is known for an AFP system to employ an infra-red (IR) heater as a heat source. In addition to being able to control the heat emitted by the IR heater by varying the input current, U.S. Pat. No. 7,731,816 proposes employing a supplemental heated gas arrangement to help heat a tool, or tows that have previously been laid on the tool, to mitigate “intensity spikes” from the IR heater, which could otherwise heat the tool or tow above a burn point of the composite material that is being deployed. In addition, U.S. Pat. No. 7,731,816 proposes a supplemental cooling mechanism, which can be controlled to expel clean, dry air (or other gases such as Nitrogen)—at or below ambient temperature—onto the tool, or onto previously laid tows, to remove heat more quickly therefrom during manufacture, to increase controllability and, again, to avoid heating near to or above the burn point.

### SUMMARY

According to a first aspect, embodiments of the present invention provide a method of manufacturing a composite article from a composite material comprising exposing a contact surface, which comes into contact with another surface during said manufacturing, to radiation pulses emitted by a pulsed radiation source.

Depending on context, manufacturing can mean either producing a new composite article or repairing an existing composite article that has, for example, been damaged.

According to a second aspect, embodiments of the present invention provide apparatus for manufacturing a composite article from a composite material, the apparatus comprising a pulsed radiation source and a controller for controlling the operation of the pulsed radiation source to expose a contact surface, which comes into contact with another surface during said manufacturing, to radiation pulses emitted by the pulsed radiation source.

According to a further aspect, embodiments of the present invention provide an automatic fiber placement system comprising an aforementioned apparatus.

According to a further aspect, embodiments of the present invention provide an apparatus for heating a contact surface, which comes into contact with another surface during said manufacturing, the apparatus comprising a pulsed radiation source and a controller for controlling the operation of the pulsed radiation source to expose the contact surface to radiation pulses emitted by the pulsed radiation source.

According to other aspects, embodiments of the present invention provide a method of manufacture, the method comprising exposing a composite structure to radiation pulses emitted by a pulsed radiation source.

According to still further aspects, embodiments of the present invention provide an apparatus comprising a pulsed radiation source and a controller for controlling the operation of the pulsed radiation source to expose a composite structure to radiation pulses emitted by the pulsed radiation source.

### BRIEF DESCRIPTION OF THE DRAWINGS

Various features and advantages of the invention will become apparent from the following description of embodiments of the invention, given by way of example only, which is made with reference to the accompanying drawings, of which:

FIG. 1 is a temperature against time graph illustrating how the surface temperature of a composite material varies when exposed to a pulse of electromagnetic radiation;

FIG. 2 is a temperature against time graph illustrating how the surface temperature of a composite material varies when exposed to a sequence of pulses of electromagnetic radiation;

FIGS. 3a and 3b are schematic diagrams of alternative heads of the kind employed on AFP systems according to embodiments of the present invention;

FIG. 4 is a schematic diagram of an alternative system in which layers of previously laid composite material move below an array of pulsed radiation sources according to embodiments of the present invention;

FIGS. 5a and 5b are schematic diagrams that illustrate two kinds of shaped reflector that can be employed to focus radiation pulses, which are emitted by respective pulsed radiation sources, onto respective targets;

FIGS. 5c and 5d are schematic diagrams that illustrate two kinds of shaped reflector that can be employed to focus radiation pulses, which are emitted by respective pulsed radiation sources, onto respective targets via radiation filters;

FIG. 6 is a schematic diagram of a circuit for controlling an AFP system according to embodiments of the present invention.

### DETAILED DESCRIPTION OF CERTAIN INVENTIVE EMBODIMENTS

Various embodiments of the present invention will now be described in more detail with reference to the accompanying drawings. It will be appreciated that embodiments of the invention are not limited in their application to the details of method and the arrangement of components as set forth in the following description or illustrated in the drawings. It will be apparent to a person skilled in the art that additional embodiments of the present invention not detailed in the description are possible and will fall within the scope of the present claims. Accordingly, the following description should not be interpreted as limiting in any way, and the scope of protection is defined solely by the claims appended hereto.

In general terms, embodiments of the present invention employ an alternative heating arrangement, which can be used in all kinds of manual or AFP manufacturing processes, for heating in a controllable manner a “contact surface” of at least one of: a mold or a tool onto which a layer or tow of prepreg is to be laid; a layer or tow of prepreg that is about to be laid, for example, onto a mold or tool; a previously laid layer or tow of prepreg before further layers or tows are laid thereon; or a composite article or part that is being repaired. It will be appreciated that the heating of a contact surface, for example to increase tack, typically results in a heating of the bulk material below the contact surface. The degree and depth of heating of the bulk material depends on various factors such as, for example, the intensity and wavelength(s) of the radiation to which the contact surface is exposed and the heating characteristics (e.g. conductivity) of the material being heated. The contact surface is referred to herein as a contact surface since, once heated, it comes into contact with another surface.

The heating system according to embodiments of the present invention employs as the heat source a pulsed electromagnetic radiation source (or simply a ‘pulsed radiation source’). As will be described, some embodiments of the present invention employ, as the pulsed radiation source, a xenon flashlamp of generally known kind, which can emit a relatively broadband radiation spectrum including one or more of IR, visible light and ultra-violet (UV) radiation components. Unless otherwise indicated, the terms ‘flash’ and ‘pulse’ will be used interchangeably herein at least in respect of flashlamp embodiments. In general terms, however, any other suitable pulsed radiation source may be employed according to alternative embodiments of the invention. For example, according to some embodiments, a pulsed laser source may be employed.

As used herein, a flashlamp is a type of electric arc lamp designed to provide short pulses (or flashes) of high energy, incoherent radiation with a relatively wide spectral content. Flashlamps have been used in photographic applications, as well as in a number of scientific, industrial and medical applications. The use of a pulsed radiation system, rather than a continuous heating system, opens up a number of new options for controlling heating temperature, as will be described herein.

Known flashlamps typically comprise a length of glass tubing forming a closed bulb with electrodes at either end. The bulb is filled with a gas that, when ‘triggered’, ionizes and conducts a high voltage pulse between the electrodes to produce the radiation (typically including visible light). Noble gases, such as argon, xenon, and krypton, can be used, and give different respective output spectra suitable for different applications. It is known to tune the output spectrum of a flashlamp by selecting different combinations of gas, gas pressure, voltage and current density among other things. Other gases including but not limited to nitrogen, neon, or helium may also be used. The glass making up the outer casing of a bulb is often fused quartz and can be doped with materials (such as cerium) in order to suppress or filter out unwanted parts of the spectrum. As used herein, for convenience, the term ‘flashlamp’ typically encompasses at least the bulb and the associated triggering circuitry.

For the heating of contact surfaces herein, the process may be optimized by adjusting one or more of a number of system parameters, including but not limited to: the number of pulses, pulse width (or flash duration), pulse intensity and pulse frequency. As will be described, shaped or 3D reflectors can also be employed to focus and control the direction of emitted radiation. Appropriate 3D reflectors may comprise flat, singly curved or doubly curved surfaces.

Testing has shown that a xenon flashlamp is capable of heating contact surfaces, for example of composite material samples, very quickly, consistently and controllably, typically exceeding the performance of other heat sources, such as known IR heat sources. Moreover, after a pulse, gasses cool relatively quickly—that is, they retain less residual heat than filament-based heaters (after ‘switch-off’)—which means flashlamps afford far greater control over heating and cooling speed during operation, compared with filament-based heaters, and may obviate entirely supplemental heating and cooling sub-systems that are taught in the prior art. This greater heating and cooling control capability also supports increased manufacturing speeds, for example, whereby relative speeds between a heater and a contact surface being heated can be increased.

Testing has also shown that pulsed flashlamp heat sources have the capability to generate surface and bulk temperatures in composite materials that are suitable for use with both thermoplastic materials and thermoset materials; the former typically requiring higher temperatures for their manufacturing processes (up to 500° C. or 600° C. for curing) while the latter typically requiring lower temperatures (up to 250° C. for curing) for their manufacturing processes. Moreover, pulsed heating sources find application in many other composite material processes, such as hot-forming, where a composite material is heated and then pressed between two faces of a die, and in the repair of composite articles, where a repair material is heated and introduced to an area of damage (which may also or instead be heated) to form a bond between adjacent parts (acting as a ‘glue’ or ‘weld’ on cooling). Embodiments of the invention encompass all such composite material manufacturing processes.

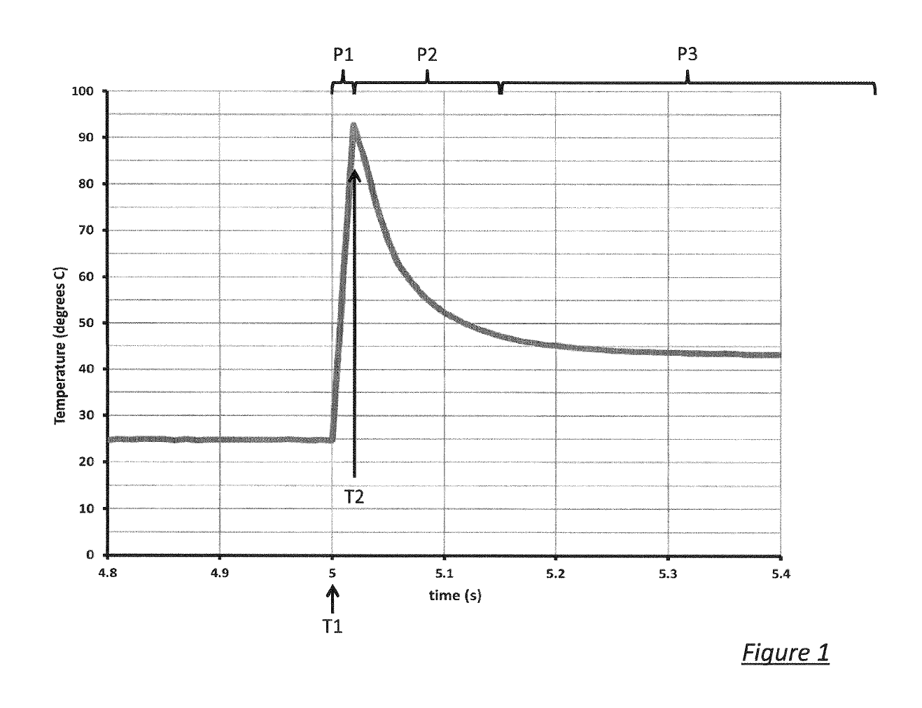

FIG. 1 is a graph showing an illustrative composite material sample surface temperature verses time profile obtained from a single flash of a xenon flashlamp onto the surface of a sample of composite prepreg material.

As illustrated in FIG. 1, a single pulse (flash) at about time T1 causes a relatively fast heating of the surface of the composite material sample. Pulse duration can typically be controlled to be from a few milliseconds to tens of milliseconds, and the time of heating of the composite material generally coincides with the duration of the pulse, during a heating phase P1. After the pulse, from time T2, the surface of the composite material cools relatively quickly, although the temperature change is not as quick as in the heating phase. The cooling phase is shown to have a reasonably exponential heat decay profile, with a characteristic, initially rapid reduction in temperature, for example during a first part P2 of the cooling phase, followed by a relatively slower reduction in temperature, for example during the remaining part P3 of the cooling phase. Overall, the cooling phase (P2+P3) is relatively much longer than the heating phase P1, with the surface temperature not returning to the starting point for a significant period of time, perhaps, ranging from milliseconds to seconds. In respect of a composite material, and more generally in respect of any other contact surface that is being heated, a cooling profile has been shown, through testing, to depend on various factors such as the tooling (or other contact surface) material, the thickness of composite lay-up, the ambient temperature and any residual temperature left in the bulb (or other pulsed heating source).

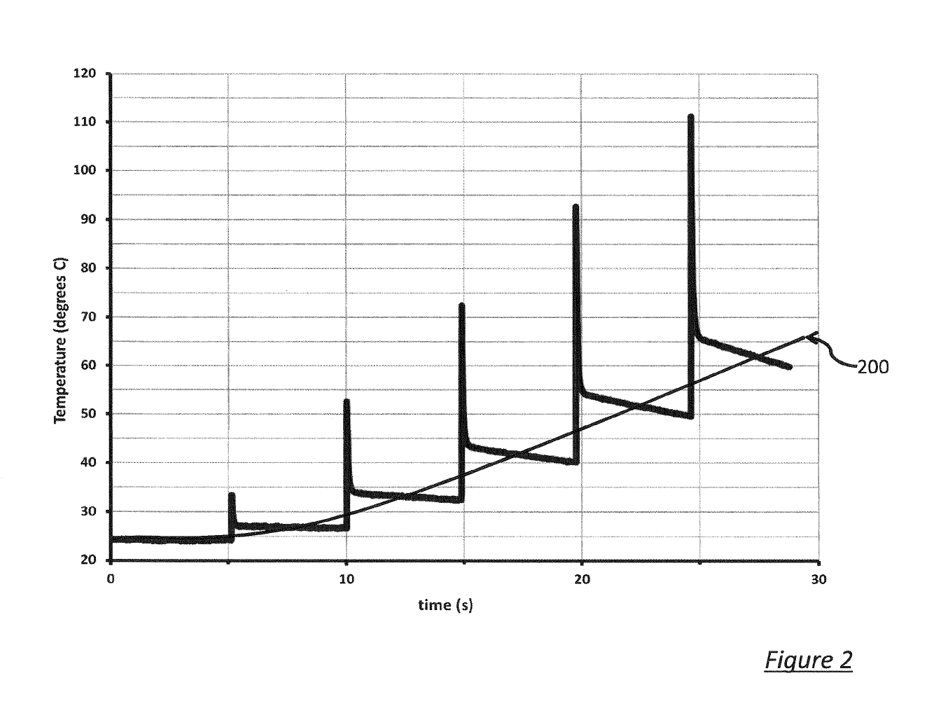

As illustrated by the graph in FIG. 2, a sequence of pulses (flashes) in quick succession can be employed to raise the surface temperature of a layer of prepreg (or any other contact surface, such as a tool) in an extremely controlled manner. The temperature can be controlled, for example, according to the number of pulses and the time between pulses, which, in the illustrative example shown, is one pulse approximately every five seconds. Higher and lower pulse frequencies can of course be employed depending on the heating profile required. Once the surface has reached a target temperature, the time between pulses can be increased to maintain the desired temperature. Of course, other pulse parameters, such as pulse intensity, may be modified instead of or in addition to pulse frequency in order to control and maintain target temperatures. It will be appreciated that a time-varying average temperature 200 on the surface, due to the relatively short heating P1, and relatively longer cooling P2+P3 phases, is closer to the temperature during the slower part P3 of the cooling phase than the temperature during the initial part P2 of the cooling phase (as illustrated in FIG. 1). This illustrates the potential to employ multiple pulses to achieve and then maintain a target temperature. The combination of fast heating (during the pulses) and relatively slow cooling (between the pulses) provides a novel method of temperature control during the manufacture or repair of composite articles. For example, according to embodiments of the present invention, as the surface temperature varies between the higher peaks and the lower cooling areas, the time delay between heating the surfaces and bringing the surfaces together may be varied to target the optimal temperature for the process. Consequently, advantage can be taken of the surface temperature peaks, without having to heat the bulk of a material to that high temperature.

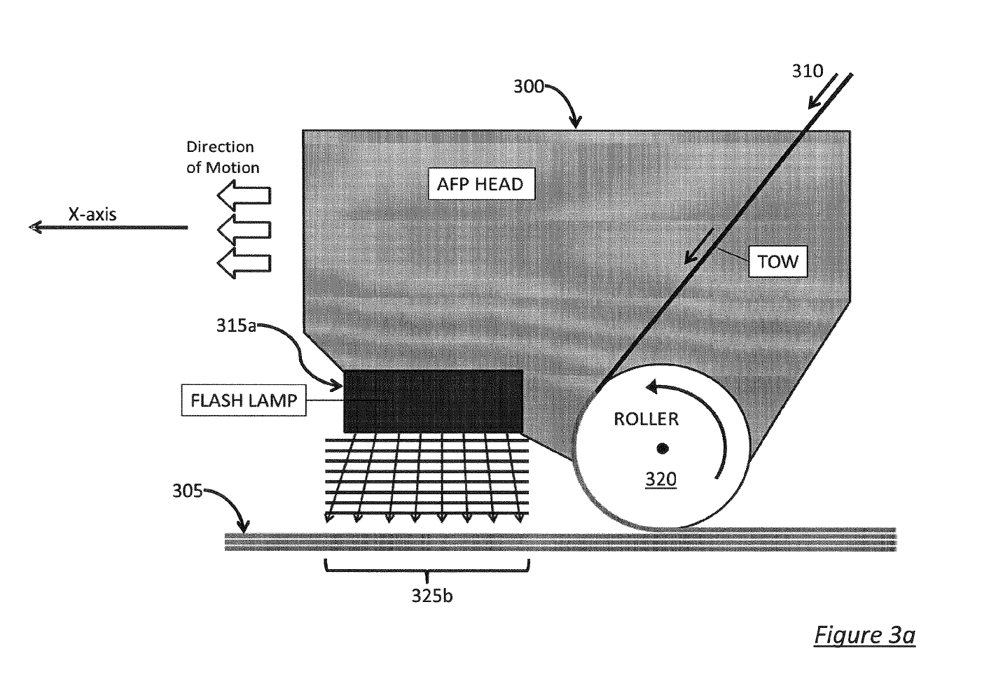

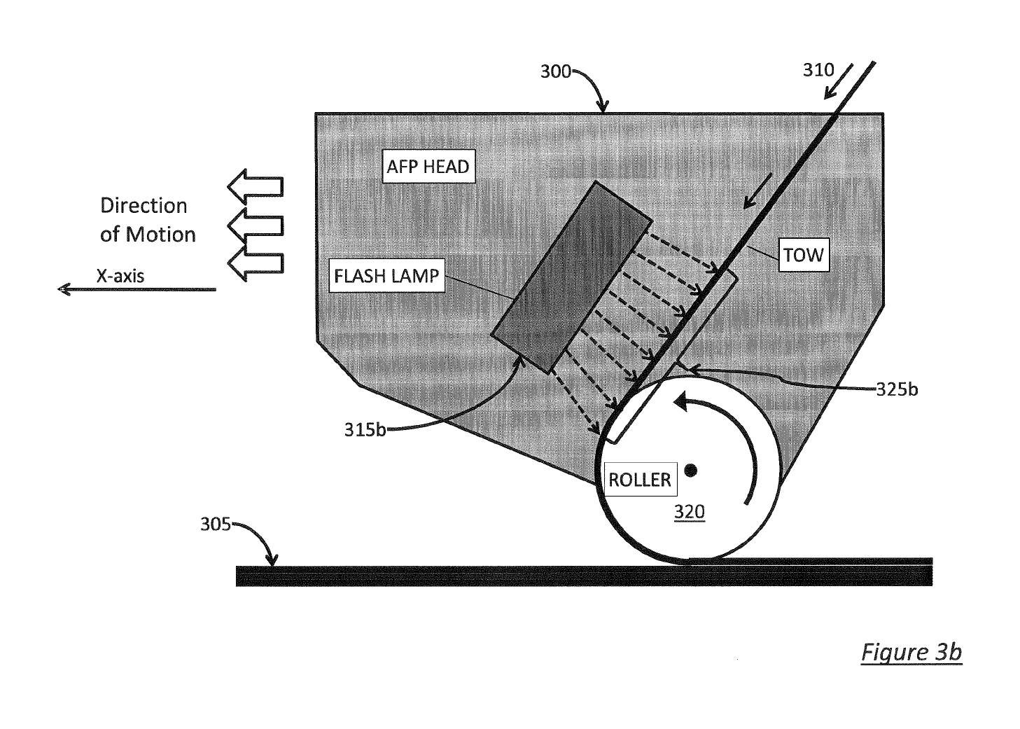

Part of an exemplary AFP system according to an embodiment of the present invention is illustrated in FIG. 3a. The parts of the system that are not illustrated are generally known from the prior art.

As shown, an AFP head 300, which can be mounted on the end of a computer controlled robotic arm (not shown) in a known way, is used to build up layers 305 of composite material by applying composite material tows 310 to the previously laid layers 305 of composite material. As illustrated, the AFP head 300 carries a flashlamp 315a ahead (in a direction of travel of the head 300, the x-axis) of a roller 320, which acts to lay down and apply pressure to a most recent tow 310. As shown, the flashlamp 315a acts to heat a region 325a —a “heating region” of the contact surface—of the previously laid tows 305, in advance of laying down the fresh tow 310, in order to increase the surface tack of the previously-laid tows. The increased tack improves adhesion between the previously laid tows 305 and the fresh tow 310.

Part of an alternative exemplary AFP system according to an embodiment of the present invention is illustrated in FIG. 3b. Elements of FIG. 3b which are the same in FIG. 3a are denoted by the same reference numerals and will not be described again. In contrast to FIG. 3a, a flashlamp 315b in FIG. 3b is mounted on a head 300 and oriented so that the emitted pulses of radiation are directed at a heating region 325b of a tow 310 that is moving through the head 300 and being laid. As in FIG. 3b, the heating operation is intended to increase tack and improve adhesion between the previously laid tows 305 and the fresh tow 310.

In further alternative embodiments of the invention, plural flashlamps (or other pulsed radiation sources) may be mounted and arranged to heat substantially simultaneously both fresh tows and previously laid layers of composite material. Of course, one or more flashlamps (or other pulsed radiation sources) may instead or in addition be mounted and arranged to heat any other element or surface of the system, as the need dictates.

In practice, flashlamp parameters such as pulse frequency can be controlled according to a required head speed—that is, the speed the head moves across the tool or previously laid tows—to reach and maintain a target temperature. In particular, as head speed is increased, the frequency of the flashes can be increased as well (or vice versa). The degree of heating may in addition, or alternatively, be controlled by varying at least one of the distance of the flashlamp from the contact surface and the angle of the flashlamp in relation to the contact surface. In addition (or alternatively) a radiation filter may be placed between the flashlamp and contact surface. Such a filter may be formed as part of the flashlight bulb or as an intermediate structure between the bulb and the contact surface being heated.

In other embodiments, the flashlamp may not be carried by a head that lays tows. For example, the flashlamp may without limitation be carried by a different robotic arm or other arrangement, which ensures that appropriate heating of the heating region is achieved. In addition, or alternatively, a system may have a bed on which a tool or previously laid layers of composite material rest, and the bed may be arranged to move relative to a static head, or each of the head and bed may be arranged to move relative to one another, for example, along the same axis (e.g. the x-axis) of movement. In other words, embodiments of the present invention accommodate, in general terms and without limitation, a head (or other arrangement that carries the pulsed radiation source) and tool or previously-laid layers of composite material (or layers about to be laid onto a tool or previously-laid layers) being arranged to move relative to one another by any suitable means.

FIG. 4 illustrates an embodiment of the present invention in which a flashlamp array 400 is arranged to heat a contact surface comprising layers 405 of composite material, which rest on a bed (not shown) that moves beneath the array 400 along an axis of movement (x-axis). The flashlamp array 400 may comprise a single flashlamp or plural flashlamps, for example, arranged in a two or three-dimensional arrangement. The array may be mounted on a gantry (not shown) above the bed. Where there are plural flashlamps, they may be controlled to flash substantially simultaneously (that is, at or near enough at the same time as each other in the context of the manufacturing speeds being employed and the heating and cooling profiles that are desired) or in a time-delayed (e.g. staggered) manner. Alternatively, each of the plural flashlamps may have an independent control system and be arranged to flash when required to attain a pre-determined heating profile on the contact surface of previously laid layers or a mold. Such an arrangement may be employed, for example, in a process in which layers of composite material are manually laid or as part of an AFP system. In this (and in all other embodiments), a distance between the flashlamp array and the contact surface to be heated may be controlled along a second axis (y-axis), thereby to increase control over heating.

In alternative embodiments (not illustrated herein), a flashlamp array could be mounted below in addition to or instead of above a contact surface to be heated. For example, by arranging a flashlamp array above and below (or, more generally, on either side) of one or more layers of composite material forming a composite structure, it would be possible to heat both respective contact surfaces substantially simultaneously, for example, to increase tack on both sides. This arrangement could, for example, find beneficial application in systems in which fresh layers or tows are laid substantially simultaneously onto both sides of an existing composite structure. Further, using flashlamp arrays to heat both sides of an existing composite structure could be employed to heat through the bulk material more quickly and evenly. This, for example, may be desirable in hot-forming applications.

There are a number of ways in which a degree of heating of a composite material by a flashlamp (or other pulsed radiation source) can be pre-characterized according to embodiments of the present invention. For example, the degree of heating by a given flashlamp of the contact surface of a given sample of composite material may be characterized empirically by measuring the surface temperature of the sample while varying one of the parameters mentioned above, including but not limited to: the distance of the flashlamp from the sample, the pulse frequency of the flashlamp, and the pulse intensity (power) and the pulse duration. The results of the characterization may then be applied to a commercial AFP system, which employs a similar kind of flashlamp to heat a similar kind of composite material, for example, to specify the flashlamp parameters and speed of motion of a head. In alternative embodiments of the present invention, a closed loop control system may be employed in which one or more temperature sensors detect the surface temperature of previously laid layers of composite material. Signals from the temperature sensor(s) are fed into head and/or flashlamp control circuits, in order to vary one or more parameters of the flashlamp(s) and/or head, to ensure that the temperature of the surface of the composite material remains close to a target temperature and does not approach a burn temperature of the material.

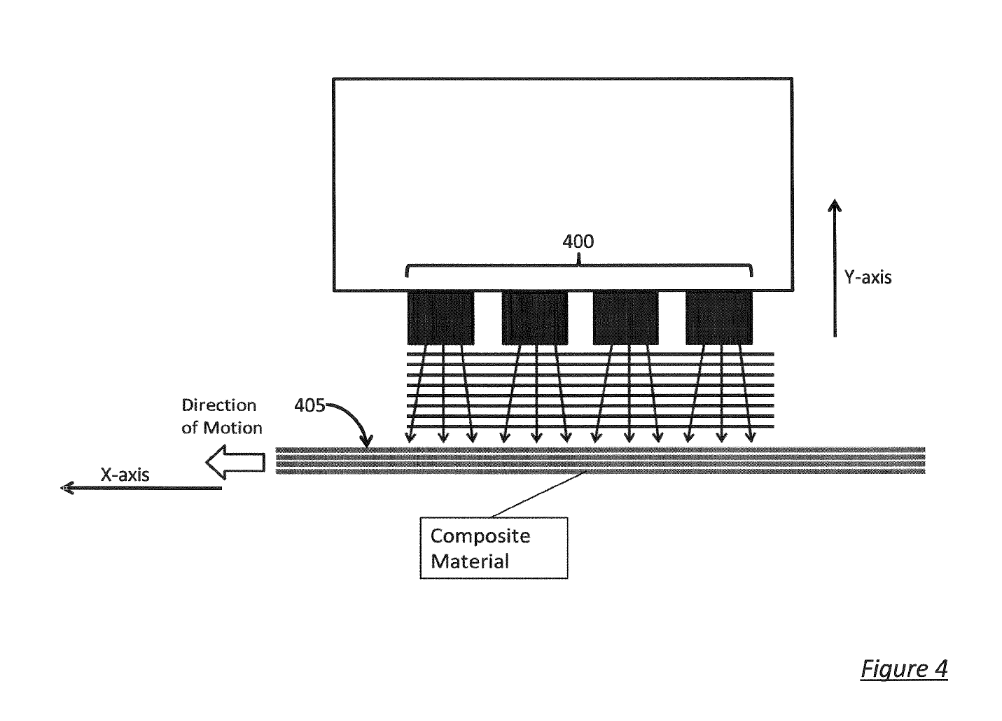

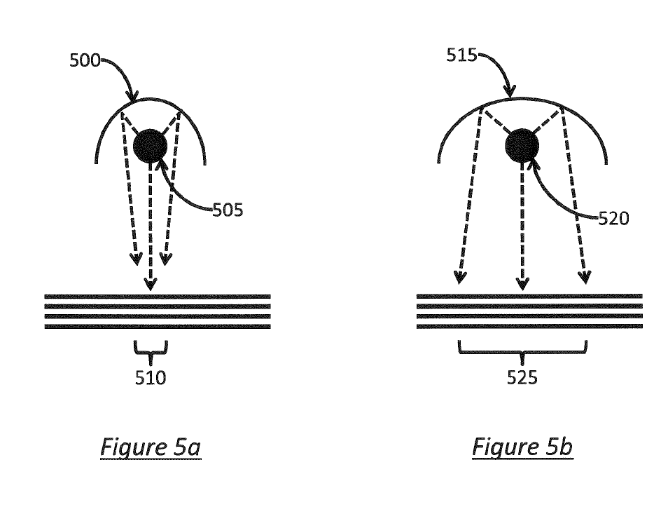

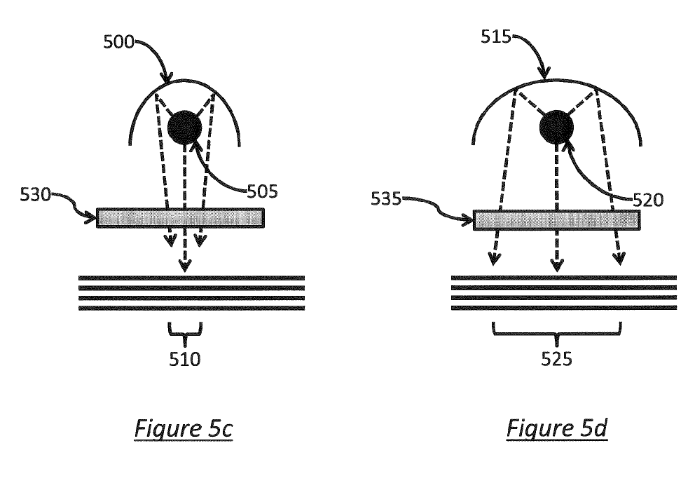

As has already been described, there are many flashlamp parameters that can be varied to influence the heating effect of any given flashlamp. In addition, the heating effect of a flashlamp may be significantly influenced by a reflector, for example, which directs flashlamp radiation towards the heating region of a mold or previously laid layer of composite material. As illustrated in FIG. 5a, a reflector 500 may be designed in a known way to reflect radiation emitted from a flashlamp 505 into a relatively narrow heating region 510 on a contact surface or, as illustrated in FIG. 5b, a reflector 515 may be designed to reflect radiation emitted from a flashlamp 520 into a relatively wide heating region 525 on a contact surface. The size of the region may in general terms be determined by the shape of the reflector, but can also be varied in operation by controlling the spacing between the flashlamp and the reflector. The intensity of the reflected radiation will typically also be significantly influenced by the surface finish and material of the reflector. Reflectors can also be wavelength-selective, for example, comprising a material that is more reflective to certain wavelengths of radiation (for example, IR wavelength components that beneficially act to heat the composite material), and less reflective to other wavelength components (for example, UV components that may act less to heat the composite material). Appropriate reflectors may be formed integrally on an interior or exterior surface of a flashlamp bulb or may be manufactured separately and then appropriately-positioned in the vicinity of the flashlamp bulb. Incident radiation that is not reflected by the reflectors in the examples in FIGS. 5a and 5b has not been illustrated or considered herein for simplicity of illustration only, and it will be immediately apparent to the skilled person that a significant portion of the radiation reaching the contact surface will be directly from the flashlamp; unless it is specifically filtered or blocked by an intervening filter arrangement.

In alternative embodiments to those illustrated in FIGS. 5a and 5b, as shown in FIGS. 5c and 5d, reflector arrangements 500, 515 may be accompanied by respective radiation filters 530, 535. The filters 530, 535 can be arranged to attenuate certain wavelengths of radiation and/or pass certain wavelength bands of radiation in a known manner. Different combinations of reflector and filter can be employed to many different requirements. Of course, filters may instead be employed without employing reflectors.

In addition to their controllability, flashlamps can have a relatively broadband radiation output. For example, as indicated above, a xenon flashlamp can be arranged to emit a relatively broadband radiation spectrum including visible light, and IR and UV radiation components. It is known that the spectral output of a flashlamp can be determined by the kind of gas used, the gas pressure in the bulb and the design of bulb itself. For any given design of flashlamp, the output spectrum may also be influenced by the voltage and current density applied across the gas. For example, higher current densities tend to deliver a flatter continuum spectrum whereas lower current densities can deliver more pronounced peaks at different wavelengths. Unwanted spectral bands may be removed by using filters. Consequently, for any given spectral output that is required for a particular composite material system, an appropriate flashlamp and filter system can be selected (or designed) and deployed.

The ability to select and control flashlamps in this way provides opportunities to optimize the output radiation profile of a flashlamp. For example, prepreg comprises both fiber and matrix component materials. Each of these component materials may absorb and heat differently for a given wavelength range. Such disparate and uneven heating characteristics may not be desirable in some scenarios. According to some embodiments of the present invention, a flashlamp source is selected that has plural output radiation peaks, which substantially correspond to radiation absorption peaks of each of the component materials. In this way, each of the component materials can be heated according to a similar heating profile (that is, temperature increase against time). This may achieve a more consistent and efficient heating profile for the composite material as a whole. In other embodiments, a flashlamp is selected to have a relatively flat, (e.g. substantially continuum) radiation spectrum which encompasses radiation absorption peaks of each of the component materials, thereby having a similarly efficient heating profile for each component material.

The relatively broadband radiation output capability of flashlamps provides additional opportunities during composite material manufacture. According to embodiments of the present invention, a flashlamp is selected that produces both IR and UV radiation components. While the IR components are selected to cause a required heating effect of a contact surface, for example, of a mold, previously laid composite material layers or layers about to be laid, the UV components are selected to at least partially cure (or initiate curing of) previously laid layers of composite material. Moreover, the matrix material of the composite may be preferentially designed to absorb the UV radiation to enhance curing. This, for example, provides an opportunity to speed up the manufacturing process by reducing, or removing entirely, the time needed, after all layers have been added, for heating and curing of the final composite article. More generally, for example, the composite material may be preferentially designed, including by doping with compounds or elements that have increased absorption or reaction characteristics in response to particular radiation wavelengths or wavelength bands that are emitted by pulsed radiation sources. As a further example, the composite material may be coated with a surface layer of an alternative material that preferentially absorbs or reflects particular wavelengths or wavelength bands that are emitted by pulsed radiation sources.

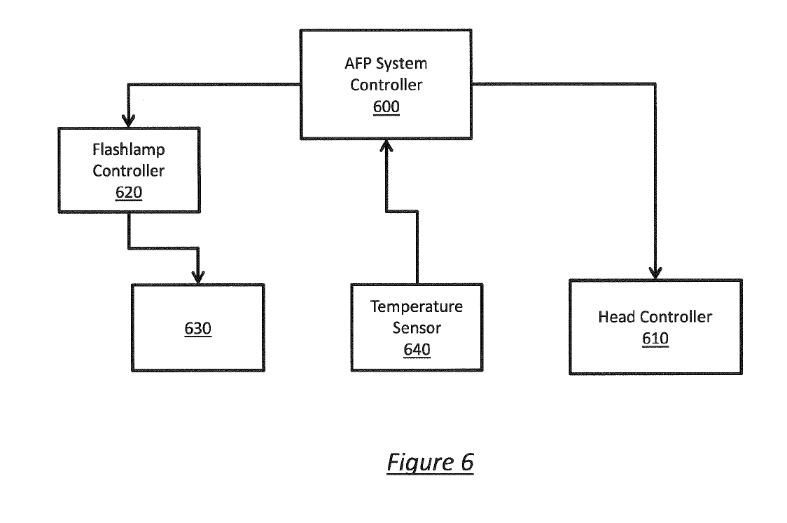

FIG. 6 illustrates an exemplary AFP control system according to embodiments of the present invention. The control system comprises an AFP system controller 600, which controls the overall operation of the system, for example, according to an embedded control program. The control program can be modified by uploading revised code, from a user terminal (not shown) in a known way, and includes a target temperature and possibly a target temperature profile (which, for example, specifies speed of heating and cooling against time). The AFP system controller 600 in turn controls, via appropriate signalling and signalling lines, a head controller 610 and a flashlamp controller 620. The head controller 610 controls the speed and direction of motion of a head, which in turn carries a flashlamp and a roller, for example, as generally described in relation to FIG. 3a or 3b. The flashlamp controller 610 controls at least the pulse intensity and pulse timing of the flashlamp. The AFP system controller 600 receives temperature signals from a temperature sensor 640. The temperature sensor 640 detects the temperature of at least a contact surface, for example, of a tool, layers of previously laid composite material or layers about to be laid. Based on the temperature signals from the temperature sensor 640, and according to its control program, the AFP system controller 600 controls the head controller 610 to change the speed of the head and/or the flashlamp controller 620 to change the flash intensity and/or frequency as required to meet the target temperature and, if present, the target temperature profile. The various controllers in FIG. 6 can be programmable controllers of known kind, for example, which contain appropriate control circuitry and memories holding appropriate control instructions. The controllers communicate via known electrical, optical or wireless interfaces.

The above embodiments are to be understood as illustrative examples of embodiments of the invention. Further embodiments of the invention are envisaged. For example, systems according to embodiments of the present invention may employ plural different kinds of flashlamp, each having a different output spectrum (or other different parameters). For example, one kind of flashlamp may output significant IR radiation components and another kind of flashlamp may output significant UV components. Moreover, different kinds of flashlamps may be mounted at different locations: for example, IR flashlamps may be mounted in front of a roller on an AFP system to heat previously laid layers of composite material while UV flashlamps may be mounted behind the roller to cause at least a degree of curing before a next layer is added. Many other alternative arrangements are conceivable based on the descriptions herein. It is to be understood that any feature described in relation to any one embodiment may be used alone, or, if the context permits, in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of manufacturing a composite article from a composite material, the method comprising exposing a contact surface, which comes into contact with another surface during said manufacture, to radiation pulses emitted by a pulsed radiation source.

2. The method of claim 1, wherein the pulsed radiation source comprises a gas discharge tube.

3. The method of claim 1, wherein the discharge tube contains a volume of a noble gas.

4. The method of claim 3, wherein the noble gas comprises xenon.

5. The method of claim 1, wherein pulses emitted by the pulsed radiation source comprise a spectrum including a wavelength that acts to at least heat the contact surface.

6. The method of claim 1, wherein the pulses emitted by the pulsed radiation source comprise a spectrum including a wavelength that acts to cure the composite material.

7. The method of claim 1, wherein the pulsed radiation source generates a broadband spectrum.

8. The method of claim 1, wherein the pulsed radiation source generates at least infra-red and ultra-violet spectral components.

9. The method of claim 7, wherein relatively long wavelength components of the spectrum act to heat the contact surface of the composite material while relatively short wavelength components of the spectrum act to cure the composite material.

10. The method of claim 7, further comprising filtering out or attenuating pre-determined components of the spectrum.

11. The method of claim 10, wherein the pre-determined components comprise components of the spectrum that would otherwise act to cure a composite material.

12. The method of claim 1, further comprising doping a bulk or a surface of the composite material with compounds or elements that are configured to absorb or react to or reflect particular wavelengths or wavelength bands that are emitted by the pulsed radiation source.

13. An apparatus for manufacturing a composite article from a composite material, the apparatus comprising:
a pulsed radiation source; and
a controller configured to control the operation of the pulsed radiation source so as to expose a contact surface, which comes into contact with another surface during said manufacture, to radiation pulses emitted by the pulsed radiation source.

14. The apparatus of claim 13, wherein the pulsed radiation source comprises a gas discharge tube.

15. The apparatus of claim 13, wherein the discharge tube contains a volume of a noble gas.

16. The apparatus of claim 15, wherein the noble gas comprises xenon.

17. The apparatus of claim 13, wherein the pulsed radiation source is configured to emit a spectrum including a wavelength that acts to at least heat the contact surface.

18. The apparatus of claim 13, wherein the pulsed radiation source is configured to emit a spectrum including a wavelength that acts to cure the composite material.

19. The apparatus of claim 13, wherein the pulsed radiation source is configured to generate a broadband spectrum.

20. The apparatus of claim 13, wherein the pulsed radiation source is configured to generate at least infra-red and ultra-violet spectral components.

21. The apparatus of claim 19, further comprising a spectral filter configured to filter out or attenuate pre-determined components of the spectrum.

22. The apparatus of claim 21, wherein the pre-determined components comprise components of the spectrum that would otherwise act to cure a composite material.
